(19) United States
(12) Patent Application Publication
(10) Pub. No.: US 2026/0310435 A1
(43) Pub. Date: Oct. 8, 2026

(54) TECHNIQUES FOR PROVIDING DYNAMIC APPLICATION IMPLEMENTATION

(71) Applicant: T-Mobile USA, Inc., Bellevue, WA (US)

(72) Inventors: Ryan Christopher Lindstrom, De Soto, KS (US); Ethan Robert Stiles, Grandview, MO (US); Peter Kimari Mwangi, Leawood, KS (US); Beth Diane Webb, Overland Park, KS (US); Dave Edward Reimer, Spring Hill, KS (US)

(21) Appl. No.: 19/098,799

(22) Filed: Apr. 2, 2025

(51) Int. Cl. G06F 8/61; G06F 8/65; G06K 7/14

(52) U.S. Cl. CPC G06F 8/61; G06F 8/65; G06K 7/1417

(57) ABSTRACT

Techniques are described herein for providing automatic implementation and configuration of software applications on user equipment. The techniques may be performed on a user equipment device and may comprise scanning a machine-readable code to obtain image data, translating the image data to obtain text data, and generating, from the text data, a request that relates to a software application to be implemented on the user equipment. The techniques may further comprise retrieving, from a remote computing device, application data that relates to the software application and implementing the software application on the user equipment based on the retrieved application data.

### BACKGROUND

Cellular networks have evolved greatly over recent years. One of the most recent changes in cellular networks is the adoption of the fifth-generation (5G) technology standard for broadband cellular networks. The adoption of the 5G technology standard by cellular networks has enabled the implementation of new applications/services on a wide variety of electronic devices.

Cellular network operators may provide software application developers with the ability to make available various software applications that operate on those cellular networks. In many cases, users would typically need to obtain a particular software application through a software application marketplace platform. However, that may be resource intensive when there is a need to obtain a number of different software applications or when software applications need to be implemented with specific configurations (e.g., for testing purposes).

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment providing automatic implementation and configuration of software applications in accordance with at least some embodiments.

FIG. 2 depicts a component diagram of an example system to be implemented in a network in order to enable automatic implementation of a software application configuration in accordance with some embodiments.

FIG. 3 depicts a block diagram illustrating interactions between a number of components that may be implemented in a system as described in accordance with embodiments.

FIG. 4 depicts a block diagram illustrating a process for receiving a request to install a software application and executing an installation of that software application in accordance with embodiments.

FIG. 5 depicts a flow diagram illustrating an exemplary process for enabling dynamic implementation of application permissions in accordance with at least some embodiments.

FIG. 6 shows an example computer architecture for a computing device capable of executing program components for implementing the functionality described above.

### DETAILED DESCRIPTION

This disclosure describes techniques that may be performed to provide automatic implementation and configuration of software applications in accordance with at least some embodiments. In the disclosure, a user equipment (UE) device may obtain information related to a software application to be installed from a machine-readable code. For example, a camera device installed upon the user equipment may be used to scan the machine-readable code in order to obtain image data that can be translated into text data by the user equipment. The translated text data may then be used to generate a request to install an indicated software application. In some cases, the software application is installed having a specified configuration and/or set of features.

Embodiments of the disclosure provide for a number of advantages over conventional systems. For example, embodiments of the disclosed system allow for software applications to be implemented having a specific configuration while minimizing resource use (e.g., time and/or computing resources). Furthermore, this allows software applications to be made available for installation even when an application marketplace is unavailable or inaccessible. This can also give a network operator (e.g., a carrier) greater control over software application deployment as it removes any obstructions that may have been implemented by the software application marketplace.

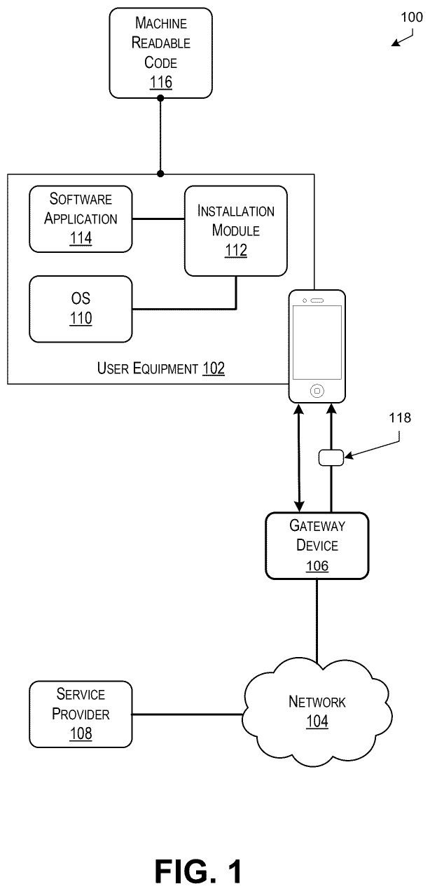

FIG. 1 depicts an example environment providing automatic implementation and configuration of software applications in accordance with at least some embodiments. In the environment 100, a user equipment 102 may be in communication with a network 104 via a gateway device 106. The network 104 may be used to access one or more service provider 108 that maintains access to software applications/services to be made available via that network 104.

The user equipment 102 can correspond to or include devices capable of communication using various connectivity standards. For example, a 5G communication channel can use millimeter wave (mmW) access frequencies of 28 GHz or more. In some implementations, a user equipment 102 can operatively couple to a gateway device 106 over a long-term evolution/long-term evolution-advanced (LTE/LTE-A) communication channel, which is referred to as a 4G communication channel. In some non-limiting examples, user equipment can include handheld mobile devices (e.g., smartphones, portable hotspots, tablets, etc.); laptop devices; wearable devices; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provides data to a remote server over a network; IoT devices such as wirelessly connected smart home appliances, etc.

A user equipment 102 can communicate with various types of access points and network equipment at the edge of a network including macro eNBs/gNBs, small cell eNBs/gNBs, relay base stations, and the like. A user equipment can also communicate with other user equipment either within or outside the same coverage area of a base station via device-to-device (D2D) communications.

The network 104 of FIG. 1 may be maintained and/or operated by one or more service providers, such as one or more wireless carriers (“operators”), that provide mobile (e.g., IMS-based) services to users (sometimes called “subscribers”) who are associated with user equipment, such as the user equipment 102. The network 104 may represent any suitable type of network, including, but not limited to, an IP Multimedia Subsystem (IMS) network or other SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of an IMS network may communicate using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

A gateway device 106 may be any suitable electronic device that is capable of managing access to one or more networks. In some embodiments, the gateway device 106 may be, or may be implemented within, a base station. A base station is a type of network access node (NAN) that can also be referred to as a cell site, a base transceiver station, or a radio base station. In some embodiments, the gateway device 106 may include one or more radio access units that provide service (e.g., cellular data service) to a user equipment 102 within a geographic area surrounding the gateway device 106 (e.g., a cell). The environment 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 602.11 access point. In some embodiments, a group of neighboring base stations/gateway devices 106 may be managed by a base station controller (not shown).

A gateway device 106 implemented as a base station may include one or more transmission mechanisms (e.g., a radio transceiver) capable of enabling wireless communication with a number of user equipment. Such base stations may be distributed over an area in a sufficiently dense manner such that multiple user equipment (e.g., mobile communication devices) in communication with the network can communicate with each other or with a terrestrial network. In some embodiments, the gateway device 106 may include one or more sensors configured to collect information about the gateway device 106 itself or an environment in which the gateway device 106 is situated. Additionally, the gateway device 106 may include one or more mechanical means of adjusting/configuring components of the gateway device. For example, the gateway device may include a radio antenna as well as a motorized mechanism for adjusting a position of the radio antenna.

A gateway device 106 implemented as a base station can wirelessly communicate with multiple user equipment 102 within wireless communication range via one or more base station antennas. The environment 100 can include base stations of different types (e.g., macro and/or small cell base stations). In some implementations, there can be overlapping geographic coverage areas (e.g., cells) for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.). In some embodiments, the network may operate using a fixed wireless access (FWA) connection. FWA is a type of wireless technology, e.g., 5G or 4G LTE wireless technology, that enables fixed broadband access using radio frequencies rather than cables.

A communication link between a user equipment 102 and a gateway device 106 may include uplink (UL) transmissions from the user equipment 102 to the gateway device 106, and/or downlink (DL) transmissions from the gateway device 106 to the user equipment 102. The downlink transmissions can also be called forward link transmissions while the uplink transmissions can also be called reverse link transmissions. Each communication link includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links can transmit bidirectional communications using frequency division duplex (FDD) (e.g., using paired spectrum resources) or Time division duplex (TDD) operation (e.g., using unpaired spectrum resources). In some implementations, the communication links include LTE and/or mmW communication links.

In embodiments, the user equipment 102 may include a computer-readable memory as well as a set of executable instructions that, when executed by one or more processors of the user equipment, can cause that user equipment to perform various functions. Such a set of executable instructions may include an operating system (OS) 110, an installation module 112, and one or more software application 114.

An OS 110 is typically software that supports a computer's basic functions, such as scheduling tasks, executing applications, and controlling peripherals. The OS 110 may be initially installed on a user equipment by a manufacturer of that user equipment 102. The OS 110 may, in addition to performing basic operations on the user equipment, make determinations about what permissions are available to each of the various software applications. For example, when a request is made to download a software application 114 onto the user equipment 102, the OS 110 may make a determination as to whether permission should be granted to do so.

An installation module 112 may be a module (e.g., a software application) configured to receive information about a software application and/or specified configuration to be implemented on the user equipment 102. In some cases, such information may be obtained from image data captured by a camera of the user equipment 102 (e.g., from a machine-readable code 116). The information may include an indication of the software application to be implemented, a version of the software application, and/or one or more features/configuration setting values to be implemented. In some cases, the information may include a memory location from which the software application may be retrieved. In some cases, the information may further include an indication of an author or creator of a machine-readable code 116 from which the information was obtained (e.g., a barcode, a QR code, or another suitable code).

Upon receiving information about an application 114 to be implemented, the installation module 112 may be configured to generate a request to be transmitted to the OS 110 in relation to the software application 114. The request may include at least a portion of the information. Upon receiving the request, the OS 110 may cause the user equipment to access a memory location (e.g., on a computer operated by a service provider 108) indicated in the request in order to receive the software application 114 via data packets 118. Once the data packets 118 have been received by the user equipment 102, the user equipment 102 may be caused to install the software application 114 with the indicated features/configuration setting values.

In accordance with various embodiments described herein, the terms “user equipment (UE),” “wireless communication device,” “wireless device,” “communication device,” “mobile device,” and “client device,” may be used interchangeably herein to describe any user equipment (e.g., the user equipment 102) that is capable of transmitting/receiving data over the network 104, perhaps in combination with other networks. A users can utilize the user equipment 102 to communicate with other users and associated user equipment via the network. For example, a cellular network operator may offer multimedia telephony services that allow a subscribed user to call or message other users via the network using his/her user equipment 102. A user can also utilize the user equipment 102 to receive, provide, or otherwise interact with various different network-based services by accessing the network 104. In this manner, an operator of the network (e.g., a carrier) may offer any type of network-based service, such as, telephony services, emergency services (e.g., E911), gaming services, instant messaging services, presence services, video conferencing services, social networking and sharing services, location-based services, push-to-talk services, and so on.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

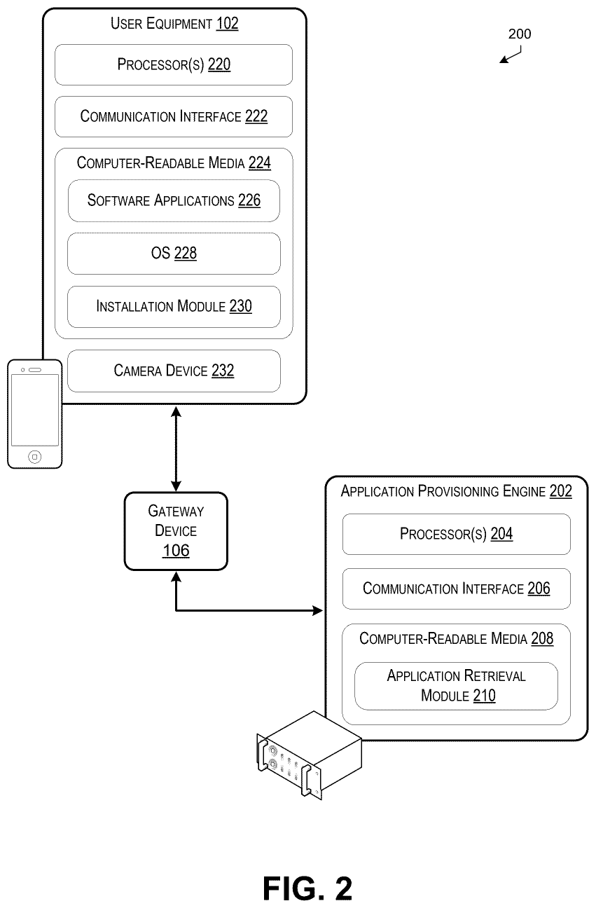

FIG. 2 depicts a component diagram of an example system 200 to be implemented in a network (e.g., a cellular network) in order to enable automatic implementation of a software application configuration in accordance with some embodiments. As depicted in FIG. 2, an application provisioning engine 202 may be executed as a combination of hardware (e.g., a network node) and software in wireless communication with a user equipment 102 operated by a user. The connection between the user equipment 102 and the application provisioning engine 202 may be made over a gateway device 106.

In some embodiments, the application provisioning engine 202 is implemented in communication with a gateway device 106. Gateway device 106 may be an example of the gateway device 106 as described in relation to FIG. 1 above. It should be noted that a network node (or any other described computing component) on which the application provisioning engine 202 is implemented may include a single computing device (e.g., a server device) or a combination of computing devices. In some cases, such a network node may be implemented as a virtual device/system (e.g., via virtual machines implemented within a cloud computing environment).

As illustrated, the application provisioning engine 202 may include one or more hardware processors 204 configured to execute one or more stored instructions. Such processors 204 may comprise one or more processing cores. Further, the application provisioning engine 202 may include one or more communication interfaces 206 configured to provide communications between the application provisioning engine 202 and other devices, such as the user equipment 102 or any other suitable electronic device.

The application provisioning engine 202 may also include computer-readable media 208 that stores various executable components (e.g., software-based components, firmware-based components, etc.). The computer-readable media 208 may store components to implement functionality described herein. While not illustrated, the computer-readable media 208 may store one or more operating systems utilized to control the operation of the one or more devices that comprise the application provisioning engine 202. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 208 may include portions, or components, that configure the application provisioning engine 202 to perform various operations described herein. For example, the computer-readable media 208 may include some combination of components configured to implement the described techniques. Particularly, the application provisioning engine 202 may include a component configured to retrieve application data to be implemented on a user equipment (e.g., application retrieval module 210). Additionally, the computer-readable media 208 may further maintain one or more databases.

An application retrieval module 210 may be configured to, when executed by the processors 204, retrieve one or more data packets related to a software application from a location in memory. In some cases, the application retrieval module 210 may receive information about a software application to be installed on a user equipment from that user equipment. Upon receiving such a request, the application retrieval module may be configured to determine a location in memory at which information for the software application is stored. In some cases, the application retrieval module may also receive an indication of a location in memory along with the request. In some cases, the location in memory may be located on a service provider computer that is remote to the application provisioning engine 202. The application retrieval module 210 may be configured to retrieve application data from the memory location and relay it to the user equipment 102 for installation.

The user equipment 102 may be an example of a user equipment 102 as described in relation to FIG. 1 above. As noted elsewhere, a user equipment 102 may include any suitable electronic device configured to interact with a network.

In embodiments, the user equipment 102 may include one or more hardware processors 220 configured to execute stored instructions. Such processors 220 may comprise one or more processing cores. Further, the user equipment 102 may include one or more communication interfaces 222 configured to provide communications between the user equipment 102 and other devices, such as an application provisioning engine 202 or another suitable electronic device.

In embodiments, the user equipment 102 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the user equipment 102. In some examples, the operations performed by devices as described herein may be supported by one or more devices similar to user equipment 102. Stated otherwise, some or all of the operations performed by a user equipment, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the user equipment 102 to perform various operations described herein. For example, the computer-readable media 224 may include some combination of components configured to implement the described techniques. In embodiments, the computer-readable media 224 of the user equipment 102 may include an operating system (OS) 228 as well as one or more software applications 226. The computer-readable media 224 may further include a component configured to generate a request related to a software application (e.g., installation, update, etc.) based on received information (e.g., installation module 230).

A software application 226 may be any suitable set of computer-executable instructions that causes the user equipment 102 to perform a function. In embodiments, the software application 226 may be supported by a remote server, such as the service provider 108 as described in relation to FIG. 1 above. In other words, when executed, the software application may cause the user equipment 102 to communicate with a remote server to perform at least a portion of the functionality provided by that software application 226. The network traffic generated during such a communication may be transmitted to the gateway device 106 to be routed to its intended destination device.

An installation module 230 may be configured to, when executed by the processors 220, receive a request to access and implement a software application. In some cases, the request may be a request to install the software application on the user equipment 102. In some cases, the request may be a request to update the software application (e.g., to a different version) or to configure the software application in a particular way (e.g., by implementing a particular set of configuration setting values). In some cases, the request may be initiated upon scanning (e.g., using a camera device 232 installed within the user equipment 102) a machine-readable code. Upon receiving the request, the application retrieval module 230 may be configured to generate and transmit a request to an OS 228 of the user equipment to cause it to execute the request.

In embodiments, the installation module 230 may receive (e.g., included in the request) information about the software application to be implemented on the user equipment 102. In some cases, this may include specific configuration settings to be implemented in relation to the software application. In some cases, this may include an indication of one or more features to be enabled/disabled within the software application. In some cases, the information may include an indication of a location in memory from which data for the software application can be retrieved.

In some embodiments, the request may be accompanied by a token or code that can be used to authenticate the request. For example, a token may be included in a machine-readable code that is generated based on at least a portion of the other information included in the machine-readable code. For example, the token may be generated as a hash function value from the other information included within the machine-readable code. In this example, the application retrieval module, before generating a request to be provided to the OS 228, may independently generate a second hash function value from the received information, which is then compared to the received token to make a determination as to whether the request is authorized.

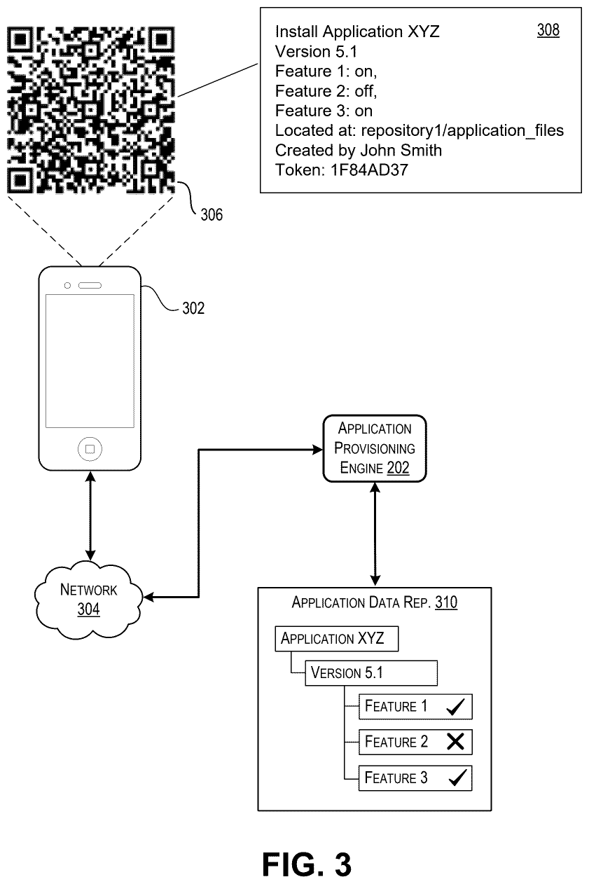

FIG. 3 depicts a block diagram illustrating interactions between a number of components that may be implemented in a system as described in accordance with embodiments. In particular, a user equipment 302 may be in communication with an application provisioning engine 202 via a network 304 (e.g., a cellular network or Local Area Network (LAN)).

In embodiments, a camera of the user equipment 302 may be used to obtain information from a machine-readable code 306. Note that the machine-readable code 306 may be any suitable encoded text data 308 that is capable of being interpreted by a computing device (such as the user equipment 302). Some non-limiting examples of machine-readable codes may include, but are not limited to, a barcode, a Quick Response (QR) code, a data matrix, or any other suitable format.

In embodiments, the user equipment 302, upon scanning the machine-readable code 306, may decode that machine-readable code to obtain text data 308. The user equipment 302 may then execute an example of the installation module 230 as described in relation to FIG. 2 above to initiate installation of a software application indicated within the text data 308. For example, the installation module 230 may be triggered to execute by a portion of the text data 308. In such an example, the installation module 230 may be configured with access to any text data that is decoded from any machine-readable code that is scanned by the user equipment 302. Accordingly, the installation module 230 may execute when the text data obtained from a machine-readable code includes an execution command for the installation module 230.

In some embodiments, the text data 308 may include a token capable of being used to authenticate that text data 308. For example, the token may represent a cryptographic function value (e.g., a hash value or encryption data) that has been generated from at least a portion of the information included in the text data (e.g., an electronic signature). In this example, the installation module 230 may verify the authenticity of the request by independently generating a new cryptographic function value based on at least a portion of the text data 308 and may then make a comparison between the received token and the newly generated cryptographic function value. In this example, the cryptographic function value may be generated using a cryptographic key that is available only to authorized entities.

Thus, upon execution of the installation module 230 and, optionally, the verification of the request, the installation module 230 may cause the user equipment 302 to submit a request to install the software application and access the application data related to the software application to the application provisioning engine 202. The application provisioning engine 202 may be implemented on a computing node operating within a network. Upon receiving a request for application data, the application provisioning engine 202 may identify a location in memory associated with that application data. In embodiments, such application data may be stored in, and retrieved from, an application data repository 310.

In embodiments, the request may include information about a number of features to be enabled/disabled and/or one or more configuration setting values. That information may have been retrieved from the text data 308 as obtained via the machine-readable code 306. In such cases, application provisioning engine 202 may generate a software data packet that is configured to implement the indicated number of features to be enabled/disabled and/or one or more configuration setting values. Subsequently, the application provision engine 202 may send the software data packet for the software application along with a command to install the software application to the installation module 230. In turn, the installation module 230 may cause the user equipment 302 to install the software application based on the software data packet. For example, the installation module 230 may direct the user equipment 302 to install the software application via an installation file that is pre-loaded on or separately downloaded to the user equipment 302, in which the installed software application is configured based on the software data packet.

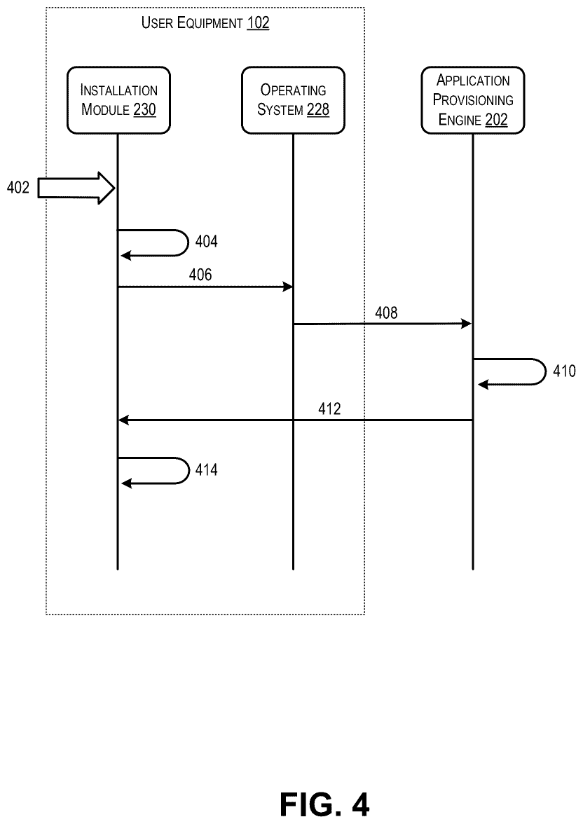

FIG. 4 depicts a block diagram illustrating a process for receiving a request to install a software application and executing an installation of that software application in accordance with embodiments. The process is performed via components of a user equipment 102 as well as an application provisioning engine 202 as reachable over a network connection.

The user equipment 102 may receive a request 402 related to a software application. An exemplary request may be a request to install or update the software application on the user equipment. As noted elsewhere, the request may be received as text data as interpreted from a machine-readable code that was scanned using a camera of the user equipment 102. In embodiments, the text data may include some combination of a location of the software application to be installed, one or more features to be enabled/disabled, one or more configuration setting values to be implemented, an identity of a user that generated the machine-readable code, an indicated software version, a token that can be used for verification, or any other suitable information.

Upon receiving the request 402, an installation module 230 may be configured to generate a second request to cause the user equipment 102 to execute the request 402 at 404. In embodiments, the installation module 230 may first make a determination as to whether the request 402 is authorized. To do this, the installation module 230 may make a determination as to whether a token received in the request 402 matches a value independently generated by the installation module 230 based on information included in the request 402. In some cases, that value may be generated using a secret cryptographic key maintained by the installation module 230.

Once the installation module 230 has generated a second request, that request may be provided to an OS 228 at 406. In some cases, the installation module 230 may provide a token to the operating system along with the request, where that token can be used to verify that the installation module 230 has authority to make the request. In such cases, that token may be a token that has been provided to the operator of the network (e.g., a carrier) by a manufacturer of the user equipment. Upon receiving the request (and token), the operating system may cause the user equipment to initiate/execute that request by providing the request to an application provisioning engine 202 at 408.

Upon receiving a request for a software application to be installed/updated on the user equipment 102, the application provisioning engine 202 may retrieve application data at 410. In some cases, this may involve identifying a data repository in which data related to the software application is stored. In some cases, such a data repository may be indicated in the request. In embodiments, where the request indicates specific features/configuration setting values to be implemented, the application provisioning engine 202 may retrieve the application data configured to implement those specific features/configuration setting values. Once the application data has been retrieved by the application provisioning engine 202, that application data is then provided back to the user equipment 102 at 412.

Upon receiving the application data from the application provisioning engine 202, the installation module 230 may cause the user equipment to install the software application that relates to that application data. In embodiments, any specific features/configuration setting values indicated in the request 402 may be implemented automatically when the software application is installed.

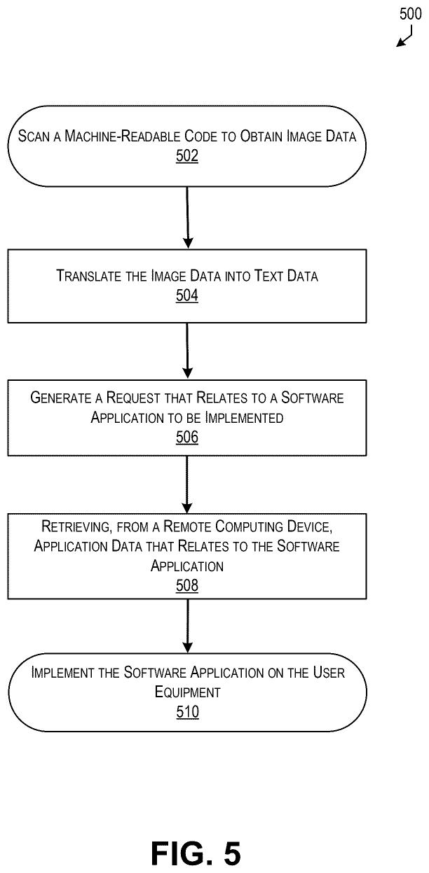

FIG. 5 depicts a flow diagram illustrating an exemplary process for enabling dynamic implementation of application permissions in accordance with at least some embodiments. The process 500 may be performed by components implemented on a user equipment, such as the user equipment 102 as described in relation to FIG. 1 above. By way of nonlimiting example, the user equipment device may be a mobile phone.

At 502, the process 500 may involve scanning a machine-readable code to obtain image data. In embodiments, the machine-readable code may be a barcode or a Quick Response (QR) code capable of being scanned using a camera.

At 504, the process 500 may involve translating the image data into text data. In some embodiments, the text data comprises at least an indication of a location in memory associated with the software application. In some embodiments, the text data comprises an indication of one or more features to be enabled or disabled.

At 506, the process 500 may involve generating a request that relates to a software application to be implemented. In embodiments, the request may be a request to install or update the software application. The request may include an indication of a version of the software application to be installed as well as one or more features/configuration setting values to be implemented.

In some embodiments, the request may be verified prior to it being provided to another computing device. In some cases, only software applications listed on an approved list may be requested in the manner described. For example, upon receiving a request to install or update a specified software application, an installation module may make a determination as to whether the software application is included on a list of approved software applications that can be requested using the disclosed techniques. If the requested software application is not included on such a list, then the request may not be approved that the process may be canceled. Alternatively, a request may be verified only if the software application related to the request is not included on a list of disapproved software applications. In some cases, only software applications stored at an approved memory location (e.g., those provided by an approved entity) may be authorized for installation using the techniques described. For example, upon receiving a request to install a software application, the installation module may make a determination as to whether the location in memory from which the software application is to be retrieved is included on a list of approved locations.

In some embodiments, the text data comprises a token that can be used for verification. In such embodiments, token may be determined to be authenticated upon comparing the token included in the text data to a second token independently generated by the installation module of the user equipment from at least a portion of the text data. For example, the installation module may use a cryptographic key to generate a hash value from a portion of the text data. In this example, the generated hash value may be compared to the token to verify the authenticity of the request. In another example, the token may be an electronic signature, and the installation module may perform a verification process for that electronic signature using the cryptographic key. In embodiments, the request may be processed only upon a determination that the token is authenticated.

At 508, the process 500 may involve retrieving, from a remote computing device, application data that relates to the software application. In embodiments, the remote computing device may be a node computing device operating within a network. In such embodiments, the application data may be retrieved from a data repository accessible to the remote computing device.

At 510, the process 500 may involve implementing the software application on the user equipment. For example, an installation module may, upon receiving application data related to the software application from the remote computing device, cause the software application to be installed upon the user equipment. In embodiments in which the text data indicates one or more features to be enabled/disabled, implementing the software application on the user equipment may include automatically configuring the software application on the user equipment based on the indication of the one or more features.

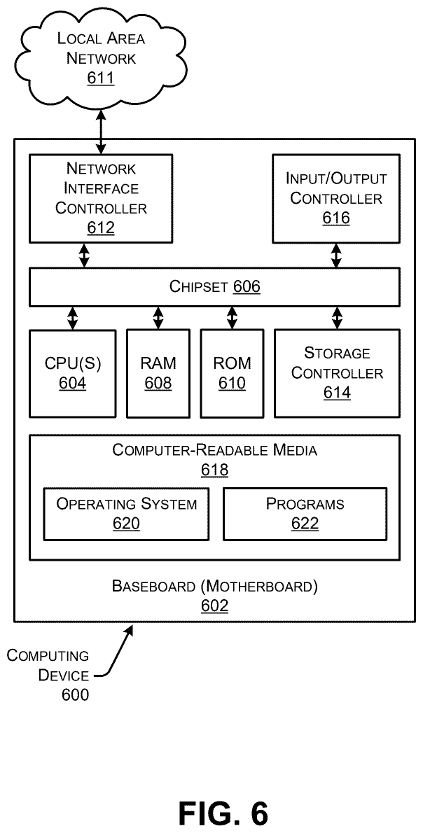

FIG. 6 shows an example computer architecture for a computing device 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a physical server as described herein, and may comprise networked devices such as servers, switches, routers, hubs, bridges, gateways, modems, repeaters, access points, etc.

The computing device 600 includes a baseboard 602, or “motherboard,” which is a printed circuit board to which a multitude of components or devices can be connected by way of a system bus or other electrical communication paths. In one illustrative configuration, one or more central processing units (CPU 604) operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 611. The chipset 606 can include functionality for providing network connectivity through a NIC 612, such as a gigabit Ethernet adapter. The NIC 612 is capable of connecting the computing device 600 to other computing devices over the network 611. It should be appreciated that multiple NICs 612 can be present in the computing device 600, connecting the computer to other types of networks and remote computer systems.

The computing device 600 can be connected to a storage device 618 that provides non-volatile storage for the computer. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by devices as described herein may be supported by one or more devices similar to computing device 600. Stated otherwise, some or all of the operations performed by an edge device, and/or any components included therein, may be performed by one or more computer device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to the other figures. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

As described herein, the computing device 600 may include one or more hardware processors (processors) configured to execute one or more stored instructions. The processor(s) may comprise one or more cores. Further, the computing device 600 may include one or more network interfaces configured to provide communications between the computing device 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the computing device 600 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause computing device 600 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
scanning, by a user equipment, a machine-readable code to obtain image data;
translating, by the user equipment, the image data to obtain text data;
generating, by the user equipment from the text data, a request that relates to a software application to be implemented on the user equipment;
retrieving, by the user equipment from a remote computing device, application data that relates to the software application; and
implementing the software application on the user equipment based on the retrieved application data.

2. The method of claim 1, wherein the machine-readable code comprises a barcode.

3. The method of claim 1, wherein the machine-readable code comprises a Quick Response (QR) code.

4. The method of claim 1, wherein the request comprises a request to install or update the software application.

5. The method of claim 1, wherein the text data comprises at least an indication of a location in memory associated with the software application.

6. The method of claim 5, wherein the application data is retrieved upon a determination that the location in memory is included on a list of approved locations.

7. The method of claim 1, wherein the text data comprises an indication of one or more features to be enabled or disabled.

8. The method of claim 1, wherein the text data comprises a token, and wherein the application data is retrieved upon a determination that the token is authenticated.

9. The method of claim 8, wherein the token is determined to be authenticated upon comparing the token to a second token generated by the user equipment from at least a portion of the text data.

10. A user equipment device comprising:
one or more processors; and
one or more non-transitory computer-readable media storing computer-executable instructions that, when executed by the one or more processors, cause the user equipment device to perform operations comprising:
scanning a machine-readable code to obtain image data;
translating the image data to obtain text data;
generating, from the text data, a request that relates to a software application to be implemented on the user equipment;
retrieving, from a remote computing device, application data that relates to the software application; and
implementing the software application on the user equipment based on the retrieved application data.

11. The user equipment device of claim 10, wherein the remote computing device comprises a node device operating within a network.

12. The user equipment device of claim 11, wherein the network comprises a cellular network.

13. The user equipment device of claim 10, wherein the user equipment device comprises a a computing device having at least a camera and a communication connection with a network.

14. The user equipment device of claim 10, wherein the application data is retrieved from a data repository accessible to the remote computing device.

15. The user equipment device of claim 10, wherein the text data comprises an indication of one or more features to be enabled or disabled.

16. The user equipment device of claim 15, wherein implementing the software application on the user equipment comprises automatically configuring the software application on the user equipment based on the indication of the one or more features.

17. One or more non-transitory computer-readable media storing computer-executable instructions that, when executed by one or more processors, cause the one or more processors to perform operations comprising:
scanning a machine-readable code to obtain image data;
translating the image data to obtain text data;
generating, from the text data, a request that relates to a software application to be implemented in the computer-readable media;
retrieving, from a remote computing device, application data that relates to the software application; and
implementing the software application in the computer-readable media based on the retrieved application data.

18. The one or more non-transitory computer-readable media of claim 17, wherein the text data comprises a token, and wherein the operations further comprise verifying an authenticity of the token.

19. The one or more non-transitory computer-readable media of claim 17, wherein the machine-readable code comprises a barcode or a Quick Response (QR) code.

20. The one or more non-transitory computer-readable media of claim 17, wherein the operations further comprise making a determination as to whether the request is authorized.
